(19) United States
(12) Patent Application Publication
(10) Pub. No.: US 2018/0096668 A1
(43) Pub. Date: Apr. 5, 2018

(54) HUE ADJUSTMENT OF A VEHICLE DISPLAY BASED ON AMBIENT LIGHT

(71) Applicant: Ford Global Technologies, LLC, Dearborn, MI (US)

(72) Inventors: Gopichandra Surnilla, West Bloomfield, MI (US); Daniel A. Makled, Dearborn, MI (US); Michael Mcquillen, Warren, MI (US)

(21) Appl. No.: 15/282,638

(22) Filed: Sep. 30, 2016

(51) Int. Cl. G09G 5/04; B60K 35/00; B60Q 3/02; B60R 1/00

(52) U.S. Cl. CPC G09G 5/04; B60K 35/00; B60Q 3/0293; B60R 1/00; G09G 2380/10; G09G 2320/0666; G01C 21/3453; B60K 2350/2008; B60K 2350/352; B60K 2350/2069; B60R 2300/8006; B60K 2350/965; G09G 2360/144

(57) ABSTRACT

Methods and apparatus are disclosed for hue adjustment of a vehicle display based on ambient light. An example vehicle includes a display, an ambient light sensor to monitor ambient light of the vehicle, and a master lighting controller. The example master light controller is to determine a target hue for the display based on the ambient light, compare the target hue to a current hue of the display, and, in response to the target hue being different than the current hue, adjust the current hue to the target hue.

### TECHNICAL FIELD

The present disclosure generally relates to vehicle displays and, more specifically, to hue adjustment of a vehicle display based on ambient light.

### BACKGROUND

Vehicles include control panels, such as a dashboard and a center console, to present information to and/or to receive information from a driver and/or passenger(s). Generally, a dashboard of a vehicle includes output devices (e.g., a speedometer, a fuel gauge, etc.) that present information to the driver. A center console may include input devices (e.g., buttons, control knobs, touchpads, etc.) that receive information from the driver and/or the passenger(s) to control various vehicle instruments (e.g., a HVAC system, a radio, etc.). The center console also may include a display that presents information related to the vehicle instruments. In some instances, the display is touchscreen that receives information from the driver and/or passenger(s).

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are disclosed for hue adjustment of a vehicle display based on ambient light. An example disclosed vehicle includes a display, an ambient light sensor to monitor ambient light of the vehicle, and a master lighting controller. The example master light controller is to determine a target hue for the display based on the ambient light, compare the target hue to a current hue of the display, and, in response to the target hue being different than the current hue, adjust the current hue to the target hue.

An example disclosed method to adjust a vehicle display hue includes monitoring, via a sensor, ambient light of a vehicle and determining, via a master lighting controller, a target hue for a vehicle display based on the ambient light. The example method also includes comparing the target hue to a current hue of the vehicle display and adjusting, in response to the target hue and the current hue being different, the current hue to the target hue.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates a vehicle in accordance with the teachings herein.

FIG. 2 is a block diagram of electronic components of the vehicle of claim 1.

FIG. 3 is a block diagram of a master light controller of the electronic components of FIG. 2 that adjusts a hue of a display and/or lighting of the vehicle FIG. 1.

FIG. 4 is a flowchart of an example method to implement the master light controller of FIG. 3 to adjust a hue of a display and/or lighting of the vehicle of FIG. 1 in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Vehicles include dashboards and center consoles to present information to and/or to receive information from a driver and/or passenger(s). Typically, a dashboard includes output devices that present information to the driver. Example dashboards may include a speedometer, a fuel gauge, an odometer, a tachometer, warning lights, etc. Some dashboards include digital displays (e.g., a digital speedometer, a digital odometer, etc.) that are illuminated to display information to the driver. Additionally or alternatively, dashboards may include analog displays (e.g., an analog speedometer, an analog odometer, etc.) that are illuminated via an adjacent lamp in dark environments. Further, example center consoles include input devices that receive information from the driver and/or the passenger(s) to control various vehicle instruments and/or systems. For example, a center console may include buttons, control knobs, touchpads, microphones, a touchscreen, etc. that enable the driver and/or passenger(s) to control a HVAC system, a media system, a hand-free calling system and/or other instruments and systems of the vehicle. In some examples, the center console includes output devices, such as a display (e.g., a display of a touchscreen) and speakers, that presents information to the driver and/or the passenger(s). For example, the display presents information related to the instruments and/or systems that are controlled by the input devices of the center console. The display may be a liquid crystal display (LCD), an organic light emitting diode (OLED) display, a flat panel display, a solid state display, etc.

In some instances, a brightness, intensity, hue and/or color temperature of light emitted by a display and/or lighting within a vehicle potentially may affect an attentiveness of a driver of the vehicle. For example, the display and/or lighting may include light emitting diodes (LEDs) that emit a cool, white or blue light. For example, the cool, blue or white light may cause a decrease in production of melatonin of a nearby person (e.g., a driver) and, thus, may potentially increase an alertness and/or attentiveness of that person. Additionally or alternatively, the cool, white or blue light may result in eye strain and/or distract the driver at night when ambient light of the vehicle is reduced, thereby potentially causing headaches to and/or affecting an attentiveness of the driver.

The example apparatus, methods, and machine readable media disclosed herein adjust a hue of vehicle display based on ambient light of a vehicle to increase an alertness and/or attentiveness of a driver operating the vehicle. For example, the hue of the display may produce a cool color temperature (e.g., between about 5000 Kelvin and 6400 Kelvin) during the day and/or at other increased levels of ambient light to enable the driver to view the vehicle display. At night and/or at other times with decreased levels of ambient light, the hue of display may produce a warm color temperature (e.g., between about 2700 Kelvin and 3000 Kelvin) to deter the driver from straining his or her eyes and/or from becoming distracted by the light. Additionally or alternatively, the hue of the vehicle display may be adjusted to produce cooler color temperatures, which decrease melatonin levels of the driver, to increase an alertness of the driver at night.

Example vehicles disclosed herein include a display and an ambient light sensor that monitors ambient light. In some examples, the display is located in a dashboard and/or a center console of an infotainment head unit. The vehicle also includes a master lighting controller that determines a target hue for the display based on the ambient light and compares the target hue to a current hue of the display. If the master lighting controller determines that the current hue does not equal the target hue, the master lighting controller adjusts the current hue to the target hue. The master lighting controller adjusts the hue of the display by adjusting an intensity of a blue component of light emitted by the display. For example, the master lighting controller reduces or decreases the intensity of the blue component in response to a decrease in the ambient light of the vehicle and/or increases the intensity of the blue component in response to an increase in the ambient light. By adjusting the hue of the display, the master lighting controller adjusts a color temperature of a display. That is, to adjust the color temperature of the display, the master lighting controller adjusts the hue of display by adjusting the intensity of the blue component of the light emitted by the display.

In some examples, the master lighting controller adjusts a hue of interior lighting of the vehicle. For example, the master lighting controller adjusts the hue of an overhead dome light, output display lighting, input device lighting, a headbar lamp, a rear head lamp, an interior door lamp, a glovebox lamp, etc. Further, the master lighting controller may be in communication with a body control module that controls lighting of the vehicle (e.g., interior lights, exterior lights) to adjust the hue of some of the interior lighting of the vehicle. In such examples, the master lighting controller determines the target hues of the display and instructs the body control module to adjust the hue of the lighting.

Further, the vehicle may include a driver camera that monitors an alertness of the driver. The master lighting controller also may be in communication with biometrics monitor (e.g., a wearable of a driver such as a Fitbit™ bracelet) of the driver that monitors biometrics data of the driver that may correspond to an alertness of the driver. In such examples, the master lighting controller adjusts the hue of the display to affect the alertness of the driver. For example, to cause the driver to become more alert, the intensity the blue component of the light emitted by the display may be increased in response to a detected decrease in the alertness of the driver. Additionally or alternatively, the hue of the display may be adjusted by decreasing the blue component of the light to decrease an increased heart rate of the driver as detected by the biometrics monitor. The master lighting controller also may adjust the hue of the display based on other factors, such as a location of the vehicle, current weather conditions, a current date or time a day, and/or drive behavior of the vehicle.

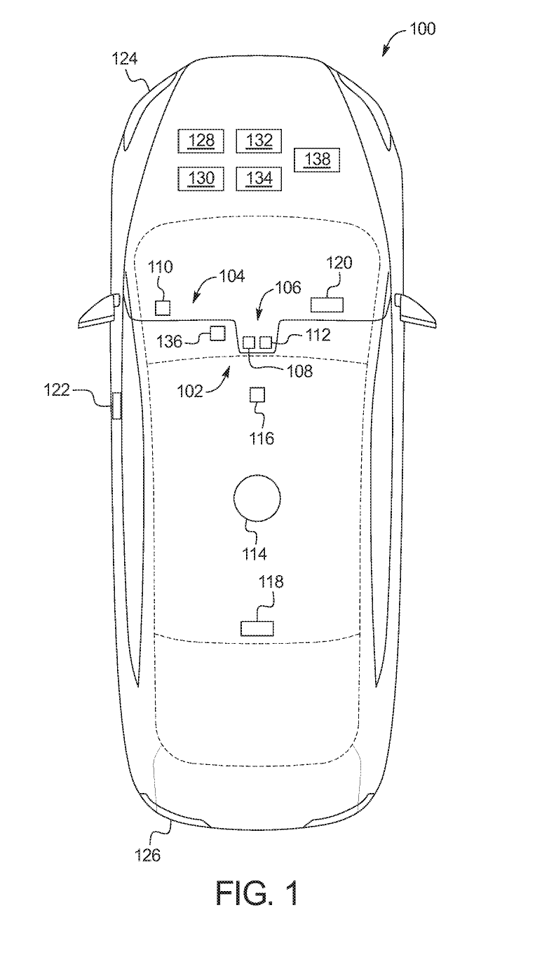

Turning to the figures, FIG. 1 illustrates an example vehicle 100 in accordance with the teachings of this disclosure. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input).

As illustrated in FIG. 1, the vehicle 100 includes an infotainment head unit 102 that includes a dashboard 104 and a center console 106. The infotainment head unit 102 provides an interface between the vehicle 100 and a user (e.g., a driver and/or passenger(s)). The infotainment head unit 102 includes digital and/or analog interfaces (e.g., input devices and output devices) to receive input from and display information for the user(s). The input devices include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a heads-up display, a center console display (e.g., a liquid crystal display (LCD), an organic light emitting diode (OLED) display, a flat panel display, a solid state display, etc.), and/or speakers. In the illustrated example, the infotainment head unit 102 includes hardware (e.g., a processor or controller, memory, storage, etc.) and software (e.g., an operating system, etc.) for an infotainment system (such as SYNC® and MyFord Touch® by Ford®, Entune® by Toyota®, IntelliLink® by GMC®, etc.). Additionally, the infotainment head unit 102 displays the infotainment system on, for example, the center console display.

The infotainment head unit 102 of the illustrated example includes a display 108, output display lighting 110, and input device lighting 112. As illustrated in FIG. 1, the display 108 is located in the center console 106 and displays information to a driver and/or passenger(s) of the vehicle 100. For example, the display 108 presents information to the driver and/or passenger(s) related to a HVAC system, a media system, a hand-free calling system and/or other system or instrument with input devices located in the center console 106 and/or throughout the vehicle 100. In other examples, the display 108 may be located in the dashboard 104 and/or any other location within the vehicle 100. Further, the display 108 may be a touchscreen or other human-machine interface (HMI) that receives information related to an instrument and/or system of the vehicle 100 from the driver and/or passenger(s). The display is, for example, an LCD, an OLED display and/or any other display for which a hue is adjustable. For example, the hue of the display 108 is adjusted by increasing and/or decreasing an intensity of a blue component of light emitted by the display 108 to increase and/or decrease a color temperature of the display 108.

In the illustrated example, the output display lighting 110 is located on the dashboard 104 and illuminates output displays of the dashboard 104. For example, the output display lighting 110 illuminates a speedometer, a fuel gauge, an odometer, a tachometer, warning lights, and/or any other output display of the dashboard 104. In other examples, the output display lighting 110 may be located in the center console 106 (e.g., to illuminate output displays of the center console 106) and/or any other location within the vehicle 100 at which it may illuminate a vehicle display. The output display lighting 110 includes digital output displays and/or lighting to illuminate analog output displays. For example, the output display lighting 110 includes a digital speedometer, a digital odometer, etc. of the dashboard 104. In such examples, the output display lighting 110 includes an LED, an LCD, an OLED display and/or any other light source for which a hue is adjustable. Additionally or alternatively, the output display lighting 110 includes lighting that is in and/or adjacent an analog speedometer, an analog odometer, etc. to illuminate the analog output display(s) in dark environments. In such examples, the output display lighting 110 includes an LED and/or any other light source for which a hue is adjustable.

The input device lighting 112 includes lighting to illuminate input devices of the vehicle 100. The output display lighting 110 includes an LED and/or any other light source for which a hue is adjustable. In the illustrated example, the input device lighting 112 includes lighting in and/or adjacent input devices (e.g., buttons, control knobs, touchpads, etc.) of the center console 106 to illuminate the input devices in dark environments. In other examples, the input device lighting 112 illuminates input devices located on the dashboard 104 and/or any other location within the vehicle 100.

The example vehicle 100 includes an overhead light 114 (e.g., a dome light), a headbar lamp 116, and a rear head lamp 118 located on an overhead surface of the vehicle 100 that illuminate an interior of the vehicle 100 for the driver and/or passenger(s). Further, the example vehicle 100 includes a glovebox lamp 120 that illuminates an interior of an opened glovebox and an interior door lamp 122 that illuminates an interior surface of a door. The overhead light 114, the headbar lamp 116, the rear head lamp 118, the glovebox lamp 120 and/or the interior door lamp 122 include an LED and/or another type of light source for which a hue is adjustable. The vehicle 100 also includes headlights 124 that illuminate upcoming terrain and brake lights 126 that indicate that the vehicle 100 is braking and/or has stopped. Further, in the illustrated example, a body control module 128 controls illumination of the overhead light 114, the headbar lamp 116, the rear head lamp 118, the glovebox lamp 120, the interior door lamp 122, the headlights 124, and the brake lights 126.

The vehicle 100 also includes sensors throughout the vehicle 100 to monitor properties and/or characteristics of the vehicle, an environment in which the vehicle 100 is located, and/or the driver of the vehicle 100. For example, the vehicle 100 includes an ambient light sensor 130 that measures and/or monitors an amount, brightness, and/or intensity of ambient light around the vehicle 100. Further, the vehicle 100 includes a global positioning sensor (GPS) receiver 132 to detect and/or monitor a position of the vehicle 100 and includes a weather sensor 134 to detect and/or monitor current weather conditions of the environment in which the vehicle 100 is located. For example, the weather sensor 134 may be windshield wiper sensors that detect rain by monitoring windshield wipers of the vehicle 100. Additionally, the example vehicle 100 includes a camera 136 on and/or around the infotainment head unit 102 that monitors, detects, and/or measures an alertness or drowsiness of the driver and/or biometrics of the driver.

As illustrated in FIG. 1, the vehicle 100 includes a master lighting controller 138 that controls illumination of lighting of the vehicle 100. For example, the master lighting controller 138 controls the illumination of the display 108, the output display lighting 110, and the input device lighting 112 of the infotainment head unit 102. Further, the master lighting controller 138 controls, via the body control module 128, illumination of the overhead light 114, the headbar lamp 116, the rear head lamp 118, the glovebox lamp 120, the interior door lamp 122, the headlights 124, and the brake lights 126 of the vehicle 100. In the illustrated example, the master lighting controller 138 is in communication with the body control module 128. Alternatively, the master lighting controller 138 may be incorporated into the body control module 128.

The master lighting controller 138 may adjust a hue of the display 108 to affect an alertness and/or attentiveness of the driver. For example, a brightness, intensity, hue and/or color temperature of light emitted by a display and/or a light may affect an attentiveness of a driver of the vehicle. White or blue light emitted by LEDs and/or LCDs produce cool color temperatures that may cause a decrease in production of melatonin of a person (e.g., the driver) exposed to the light. As a result, adjusting the hue of the display to produce cooler color temperatures may potentially cause that person to be more alert and/or awake. For, example if the ambient light sensor 130 detects that it is nighttime (e.g., a time during which the driver is more likely to be drowsy) and/or the camera 136 detects a decrease in an attentiveness (e.g., an increase in drowsiness) of the driver, the master lighting controller 138 adjusts the hue of the display 108 by increasing an intensity of a blue component of light emitted by the display 108. As a result, the display 108 has a cooler color temperature to cause the driver to become more alert. In other instances, cool color temperatures of the display 108 potentially may result in eye strain and/or distract the driver, thereby potentially affecting an attentiveness of the driver. For example, at night when the ambient light measured by the ambient light sensor of the vehicle 100 is reduced, cool color temperature of the display 108 may result in eye strain of and/or otherwise distract the driver. Thus, when the ambient light sensor 130 detects reduced ambient light and/or when the camera 136 detects that the driver is distracted, the master lighting controller 138 may adjust the hue to produce a warmer color temperature of the display 108 by decreasing an intensity of a blue component of light emitted. Additionally or alternatively, the master lighting controller 1388 may adjust the hue of the output display lighting 110, the input device lighting 112, the overhead light 114, the headbar lamp 116, the rear head lamp 118, the glovebox lamp 120 and/or the interior door lamp 122 to affect the attentiveness and/or alertness of the driver.

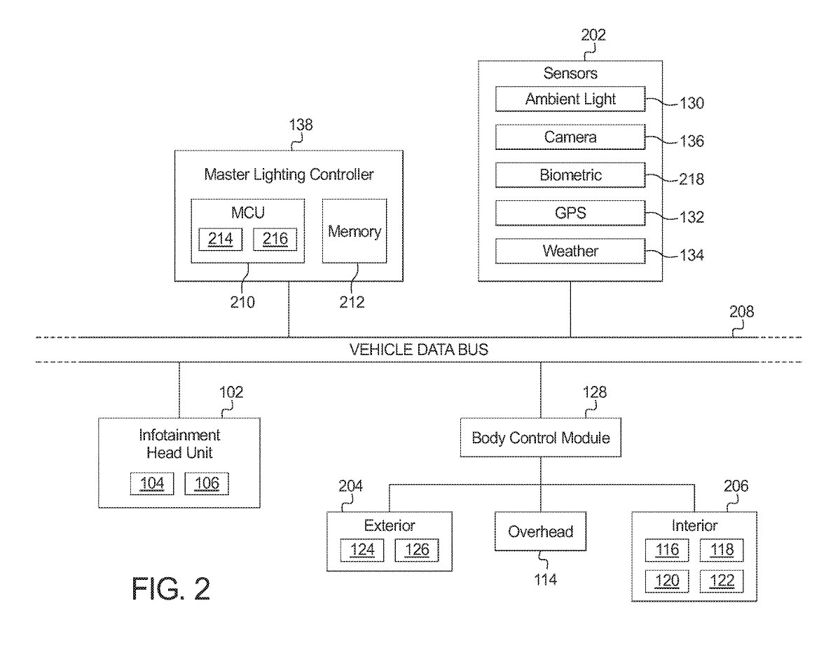

FIG. 2 is a block diagram of electronic components 200 of the vehicle 100 of FIG. 1. The electronic components 200 include the example master lighting controller 138, example sensors 202, the example infotainment head unit 102, the example body control module 128, the example exterior lighting 204, the example overhead light 114, example interior lighting 206, and an example vehicle data bus 208.

The master lighting controller 138 includes a microcontroller unit, controller or processor 210 and memory 212. In the illustrated example, the master lighting controller 138 is structured to include a hue determiner 214 and a light adjuster 216. In some examples, the hue determiner 214, the light adjuster 216 and/or, more generally, the master lighting controller 138 are incorporated into a main on-board computing platform and/or one or more electronic control units (ECUs) with its own processor 210 and memory 212. The processor 210 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 212 may be volatile memory (e.g., RAM including non-volatile RAM, magnetic RAM, ferroelectric RAM, etc.); non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 212 includes multiple kinds of memory, particularly volatile memory and non-volatile memory.

The memory 212 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 212, the computer readable medium, and/or within the processor 210 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

In the illustrated example, the hue determiner identifies and/or monitors the respective current hues of the display(s) and/or light(s) of the vehicle 100. For example, the hue determiner 214 identifies the current hue of the display 108 of the infotainment head unit 102. Additionally or alternatively, the hue determiner 214 identifies the respective current hues of the output display lighting 110 of the dashboard 104 and/or the input device lighting 112 of the center console 106. Further, the hue determiner 214 may identify the respective current hue of one or more of the overhead light 114 and/or the headbar lamp 116, the rear head lamp 118, the glovebox lamp 120, and/or the interior door lamp 122 of the interior lighting 206. The hue determiner 214 also collects, receives, and/or otherwise obtains data from the sensors 202. The hue determiner 214 utilizes the collected data to determine the respective target hues for the display(s) and/or light(s) of the vehicle 100, such as the display 108, the output display lighting 110, the input device lighting 112, the overhead light 114, the headbar lamp 116, the rear head lamp 118, the glovebox lamp 120, and/or the interior door lamp 122.

The light adjuster 216 controls the display(s) and/or light(s) of the vehicle 100. Based on a current hue and a target hue determined by the hue determiner 214, the light adjuster 216 may adjust the hue of a display or light of the vehicle 100. For example, if the light adjuster 216 determines that the target hue of the display 108 is different than the corresponding current hue, the light adjuster 216 adjusts the current hue of the display 108 to its target hue. Additionally or alternatively, the light adjuster 216 compares the current and target hues and may adjust the current hue of the output display lighting 110 and/or the input device lighting 112. In some examples, the light adjuster 216 compares the current and target hues and may adjust, via the body control module 128, the current hue of the overhead light 114, the headbar lamp 116, the rear head lamp 118, the glovebox lamp 120, and/or the interior door lamp 122. Further, the light adjuster 216 of the master lighting controller 138 controls, via the body control module 128, the headlights 124 and the brake lights 126 of the exterior lighting 204.

The sensors 202 are arranged in and around the vehicle 100 to monitor properties of the vehicle 100, the environment in which the vehicle 100 is located, and/or the driver of the vehicle. One or more of the sensors 202 may be mounted to measure properties around an exterior of the vehicle 100. Additionally or alternatively, one or more of the sensors 202 may be mounted inside a cabin of the vehicle 100 or in a body of the vehicle 100 (e.g., an engine compartment, wheel wells, etc.) to measure properties in an interior of the vehicle 100. In the illustrated example, the sensors 202 include the ambient light sensor 130 that monitors the ambient light of the surrounding environment of the vehicle, the camera 136 that monitors the alertness and/or biometrics of the driver, a biometrics sensor 218 such as a wearable of a driver (e.g., a Fitbit™ bracelet worn by the driver) that monitors the biometrics of the driver, the GPS receiver 132 that monitors the location of the vehicle 100, and/or the weather sensor 134 that monitors the current weather conditions of the surrounding environment of the vehicle 100. The data collected by the sensors 202 is retrieved by the hue determiner 214 to determine a target hue for a display and/or a light of the vehicle 100.

The body control module 128 is an electronic control unit (ECU). An ECU monitors and controls the subsystems of the vehicle 100. For example, ECUs of the vehicle 100 are discrete sets of electronics that include their own circuit(s) (e.g., integrated circuits, microprocessors, memory, storage, etc.) and firmware, sensors, actuators, and/or mounting hardware. The ECUs communicate and exchange information via a vehicle data bus (e.g., the vehicle data bus 208). Additionally, the ECUs may communicate properties (e.g., status of the ECUs, sensor readings, control state, error and diagnostic codes, etc.) to and/or receive requests from each other. For example, the vehicle 100 may have seventy or more ECUs that are positioned in various locations around the vehicle 100 and are communicatively coupled by the vehicle data bus 208. The body control module 128 controls one or more subsystems throughout the vehicle 100, such as lighting, power windows, power locks, an immobilizer system, power mirrors, etc. For example, the body control module 128 includes circuits that drive one or more of relays, brushed direct current (DC) motors, stepper motors, LEDs, etc. In the illustrated example, the body control module 128 is in communication with the master lighting controller 138 to enable the master lighting controller 138 to adjust the control the exterior lighting 204, the overhead light 144, and/or the interior lighting 206.

The vehicle data bus 208 communicatively couples the master lighting controller 138, the sensors 202, the infotainment head unit 102, and the body control module 128. In some examples, the vehicle data bus 208 includes one or more data buses. The vehicle data bus 208 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc. The vehicle data bus 208 may be a wired or a wireless data bus. For example, the master lighting controller 138 may wirelessly communicate with the exterior lighting 204, the overhead light 144, and/or the interior lighting 206 via a wireless data bus and/or any other wireless communication systems.

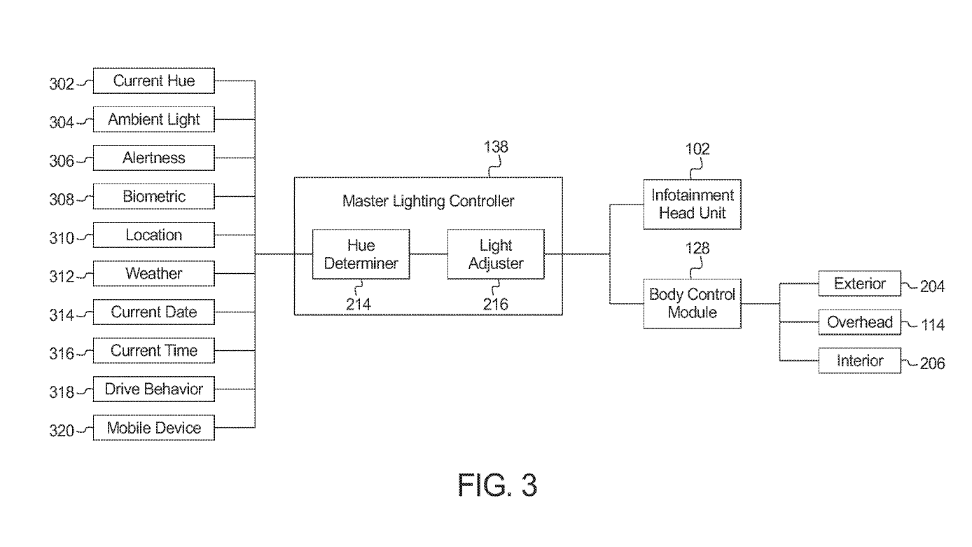

FIG. 3 is a block diagram of the master lighting controller 138 that monitors, adjusts and/or otherwise controls hue(s) of the respective display(s) and/or light(s) of the vehicle 100. As illustrated in FIG. 3, the hue determiner 214 collects current hue data 302 from the display 108 and/or the other lights of the infotainment head unit 102, the overhead light 114, and/or the interior lighting 206 of the vehicle 100. The hue determiner 214 also collects ambient light data 304 from the ambient light sensor 130. In some examples, the hue determiner 214 also collects driver alertness data 306 from the camera 136, biometric data 308 from the camera 136 and/or the biometrics sensor 218, vehicle location data 310 from the GPS receiver 132, weather conditions data from the weather sensor 134, a current date 314, a current time 316, and/or driver behavior data 318. Additionally or alternatively, the hue determiner 214 is in communication with a mobile device of the driver to collect mobile device data 320 (e.g., hue data) from the mobile device. For example, the hue determiner 214 may utilize the mobile device data 320 to determine that the target hue of the display 108 equals and/or is similar to a hue of a display of the mobile device. More generally, the hue determiner 214 determines target hues for the display 108 and/or the other lights of the vehicle 100 based on the collected data.

The light adjuster 216 collects the current hue data 302 and the determined target hue data from the hue determiner 214 and compares the corresponding current and target hues. For a display and/or light of the vehicle 100 in which the target hue is different than the current hue, the light adjuster 216 adjusts the current hue to the target hue. For example, the light adjuster 216 compares the target hue of the display 108 to the current hue of the display. If the target hue and the current hue of the display 108 are different, the light adjuster 216 adjusts the current hue to the target hue of the display 108. In some examples, the light adjuster 216 also adjusts the hue of one or more of the other displays and/or lights of the infotainment head unit 102 and, via the body control module 128, one or more of the lights of the overhead light 114 and/or the interior lighting 206. Further, the light adjuster 216 may control the exterior lighting 204 of the vehicle 100 via the body control module 128.

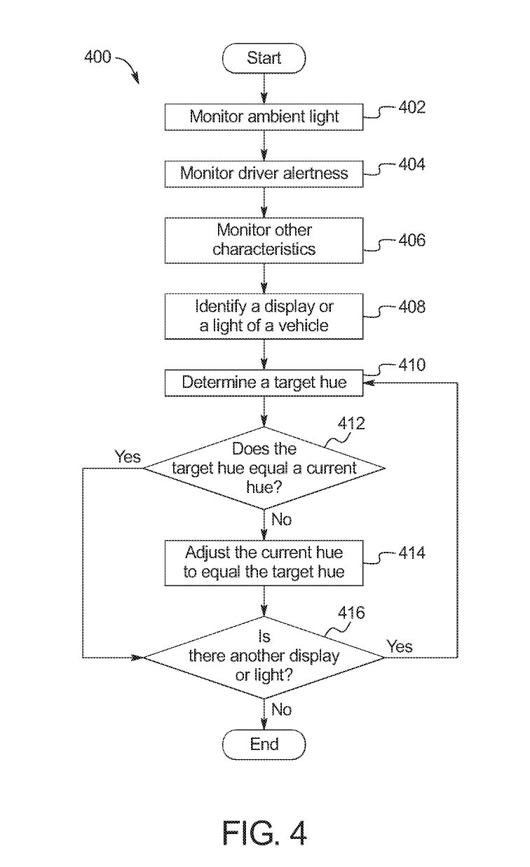

FIG. 4 is a flowchart of an example method 400 to monitor and adjust a hue of display(s) and/or lighting of a vehicle. The flowchart of FIG. 4 is representative of machine readable instructions that are stored in memory (such as the memory 212 of FIG. 2) and include one or more programs which, when executed by a processor (such as the processor 210 of FIG. 2), cause the vehicle 100 to implement the example hue determiner 214, the example light adjuster 216 of FIGS. 2-3 and/or, more generally, the example master lighting controller 138 of FIGS. 1-3. While the example program is described with reference to the flowchart illustrated in FIG. 4, many other methods of implementing the example hue determiner 214, the example light adjuster 216 and/or, more generally, the example master lighting controller 138 may alternatively be used. For example, the order of execution of the blocks may be rearranged, changed, eliminated, and/or combined to perform the method 400. Further, because the method 400 is disclosed in connection with the components of FIGS. 1-3, some functions of those components will not be described in detail below

Initially, at block 402, the ambient light sensor 130 monitors the ambient light of the surrounding environment of the vehicle 100. At block 404, the method 400 including monitoring an alertness of the driver of the vehicle 100. For example, the camera 136 monitors the driver and/or the biometrics sensor 218 to determine and/or detect an alertness and/or attentiveness of the driver. At block 406, the method includes monitoring other characteristics of the vehicle 100, the surrounding environment, and/or the driver. For example, the GPS receiver 132 monitors the location of the vehicle and/or the weather sensor 134 monitors current weather conditions.

At block 408, the master lighting controller 138 identifies a display or a light of the vehicle 100. For example, the master lighting controller 138 identifies the display 108 of the infotainment head unit 102. At block 410, the hue determiner 214 of the master lighting controller determines a target hue based on the information and/or data collected at blocks 402, 404, 406. For example, the hue determiner 214 determines the target hue to equal a hue that enables the driver to be alert and/or attentive. At block 412, the light adjuster 216 determines whether the target hue determined by the hue determiner 214 equals a current hue identified by the hue determiner 214. If the light adjuster 216 determines that the target hue and the current hue are different, the method 400 proceeds to block 414 at which the light adjuster 216 adjusts the current hue to the target hue. Upon adjusting the current hue at block 414 or determining that the target hue equals the current hue at block 416, the master lighting controller 138 determines whether there is another display or light of the vehicle 100. If there is another display or light, the method 400 ends. If there is another display or light, the method 400 repeats blocks 410, 412, 414, 416 until no other display or light is identified. For example, the method 400 repeats blocks 410, 412, 414, 416 the output display lighting 110, the input device lighting 112, the overhead light 114, the headbar lamp 116, the rear head lamp 118, the glovebox lamp 120 and/or the interior door lamp 122.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a display;
an ambient light sensor to monitor ambient light of the vehicle; and
a master lighting controller to:
determine a target hue for the display based on the ambient light;
compare the target hue to a current hue of the display; and
in response to the target hue being different than the current hue, adjust the current hue to the target hue.

2. The vehicle of claim 1, wherein the master lighting controller includes a hue determiner and a light adjuster, the hue determiner is to identify the current hue and determine the target hue, the light adjuster is to compare the target hue to the current hue and adjust the current hue.

3. The vehicle of claim 1, wherein the display is located in an infotainment head unit, the infotainment head unit includes a center console and a dashboard.

4. The vehicle of claim 1, wherein the master lighting controller is to adjust a hue of interior lighting of the vehicle based on the ambient light.

5. The vehicle of claim 4, wherein the interior lighting includes an overhead light, output display lighting, and input device lighting.

6. The vehicle of claim 1, further including a body control module in communication with the master lighting controller, the master lighting controller is to adjust the current hue of the display and control exterior lights of the vehicle via the body control module.

7. The vehicle of claim 1, further including a driver camera to monitor an alertness of a driver of the vehicle, the master lighting controller is to determine the target hue of the display further based on the alertness of the driver.

8. The vehicle of claim 1, further including a GPS receiver to monitor a location of the vehicle, the master lighting controller is to determine the target hue of the display further based on the location of the vehicle.

9. The vehicle of claim 1, further including a weather sensor to monitor current weather conditions, the master lighting controller is to determine the target hue of the display further based on the current weather conditions.

10. The vehicle of claim 1, wherein the master lighting controller is to determine the target hue of the display further based on biometrics of a driver and drive behavior of the vehicle.

11. A method to adjust a vehicle display hue, the method comprising:
monitoring, via a sensor, ambient light of a vehicle;
determining, via a master lighting controller, a target hue for a vehicle display based on the ambient light;
comparing the target hue to a current hue of the vehicle display; and
adjusting, in response to the target hue and the current hue being different, the current hue to the target hue.

12. The method of claim 11, further including adjusting an intensity of a blue component of light emitted by the vehicle display to adjust the current hue of the vehicle display.

13. The vehicle of claim 11, wherein adjusting the current hue of the vehicle display adjusts a color temperature of the vehicle display.

14. The method of claim 11, further including adjusting a hue of interior lighting and the vehicle display based on the ambient light.

15. The method of claim 11, wherein adjusting the current hue of the vehicle display includes decreasing an intensity of a blue component of light emitted by the vehicle display in response to a decrease in the ambient light.

16. The method of claim 11, further including:
monitoring an alertness of a driver of the vehicle via a driver camera; and
adjusting the current hue of the vehicle display further based on the alertness of the vehicle.

17. The method of claim 16, wherein adjusting the current hue of the vehicle display includes increasing an intensity of a blue component of light emitted by the vehicle display in response to a decrease in the alertness of the driver.

18. The method of claim 11, further including:
monitoring a location of the vehicle via a GPS receiver; and
determining the target hue of the vehicle display further based on the location of the vehicle.

19. The method of claim 11, further including:
monitoring current weather conditions via a weather sensor of the vehicle; and
determining the target hue of the vehicle display further based on the current weather conditions.

20. The method of claim 11, wherein adjusting the current hue of the vehicle display is further based on biometrics of a driver and drive behavior of the vehicle.
